(19) United States
(12) Patent Application Publication
(10) Pub. No.: US 2024/0256973 A1
(43) Pub. Date: Aug. 1, 2024

(54) TRAINING A MACHINE LEARNING MODEL USING A DISTRIBUTED MACHINE LEARNING PROCESS

(71) Applicant: Telefonaktiebolaget LM Ericsson (publ), Stockholm (SE)

(72) Inventors: Konstantinos VANDIKAS, Solna (SE); Athanasios KARAPANTELAKIS, Solna (SE); Sunil Kumar VUPPALA, Bangalore (IN)

(21) Appl. No.: 18/561,893

(22) PCT Filed: May 19, 2021
(86) PCT No.: PCT/EP2021/063302

§ 371 Date: Nov. 17, 2023

(51) Int. Cl. G06N 20/00

(52) U.S. Cl. CPC G06N 20/00

(57) ABSTRACT

There is provided a computer implemented method for use in a distributed machine learning process for training a machine learning model, wherein the training is distributed across a plurality of computing nodes and updates to the machine learning model, as determined by the plurality of computing nodes, are aggregated using secure multi party computation. The method includes: i) obtaining an aggregated characteristic of updates to the machine learning model provided by a first subset of the plurality of computing nodes; ii) comparing the aggregated characteristic to an equivalent reference; and iii) identifying whether the first subset of nodes are contributing updates that are corrupting the machine learning model, based on the comparison.

### TECHNICAL FIELD

This disclosure relates to methods, nodes and systems in a communications network. More particularly but non-exclusively, the disclosure relates to methods and nodes for use in a distributed machine learning process for training a machine learning model.

### BACKGROUND

Secure multi party computational techniques (such as secure aggregation) are used for the purposes of preserving the privacy of users when collecting arithmetic data that will later on be used to produce aggregates—more specifically multi party sums of data.

Typically in these techniques, each user or contributor (e.g. computing node) provides individual contributions that are altered using an offset or shared secret. As such, the individual contributions are masked. However, the shared secret is such that when the contributions of the contributors are aggregated, it cancels out to leave the (true) value of the aggregated values. In this way, individual values may be masked, whilst still allowing accurate unmasked aggregated values to be obtained.

The technique is often used in distributed machine learning processes such as Federated Learning since Federated Averaging makes use of the sum of neural parameters and then divides that proportionally to the number of users in relation to the number of samples that each user had used to produce its corresponding neural parameters.

Secure multi party computational techniques such as secure aggregation are successful at concealing the information that each user contributes to a Federation since the central server only receives masked input and the masks are only cancelled out during the averaging process.

As an example, in pairwise masking, pairs of computational nodes contributing to a Federation exchange a secret key or mask. One of the pair then adds the key to the value that it intends to contribute to the federation, and the other subtracts the key. Thus, the individual values are masked, but the sum of the pair of values is equal to the equivalent unmasked value.

More information on the use of secure aggregation in machine learning may be found, for example, in the paper by K. Bonawitz et al. entitled “Practical Secure Aggregation for Privacy-Preserving Machine Learning”; CCS '17: Proceedings of the 2017 ACM SIGSAC Conference on Computer and Communications Security October 2017 Pages 1175-1191.

### SUMMARY

Despite the effectiveness of secure aggregation in protecting privacy, it can be problematic in cases of malicious attack where one or more users deliberately try to shift a federation. One example of such shift could be intentional changes in the labels (assuming a classification problem) where one or more users will decide to label certain samples differently (but consistently among themselves) to change the output of the model. This is known as a poison attack.

One solution to address accountability in Federated Learning is by way of a blockchain as described, for example, in the paper by Mugunthan et al. 2020 entitled “BlockFLow: An Accountable and Privacy-Preserving Solution for Federated Learning”. Despite its advantages such as immutability of input, the use of a blockchain in federated learning can be problematic since its ledger can grow very quickly in cases where there are many participants, thus increasing the computational cost when verifying their transactions.

It is an object of the disclosure herein to address some of these issues, amongst others.

Thus, according to a first aspect there is provided a computer implemented method for use in a distributed machine learning process for training a machine learning model, wherein the training is distributed across a plurality of computing nodes and updates to the machine learning model, as determined by the plurality of computing nodes, are aggregated using secure multi party computation. The method comprises: i) obtaining an aggregated characteristic of updates to the machine learning model provided by a first subset of the plurality of computing nodes; ii) comparing the aggregated characteristic to an equivalent reference; and iii) identifying whether the first subset of nodes are contributing updates that are corrupting the machine learning model, based on the comparison.

According to a second aspect there is a computer program comprising instructions which, when executed on at least one processor, cause the at least one processor to carry out the method of the first aspect.

According to a third aspect there is a carrier containing a computer program according to the second aspect, wherein the carrier comprises one of an electronic signal, optical signal, radio signal or computer readable storage medium.

According to a fourth aspect there is a computer program product comprising non transitory computer readable media having stored thereon a computer program according to the second aspect.

According to a fifth aspect there is an apparatus for use in a distributed machine learning process for training a machine learning model, wherein the training is distributed across a plurality of computing nodes and updates to the machine learning model, as determined by the plurality of computing nodes, are aggregated using secure multi party computation. The apparatus comprises a memory comprising instruction data representing a set of instructions, and a processor configured to communicate with the memory and to execute the set of instructions. The set of instructions, when executed by the processor, cause the processor to: i) obtain an aggregated characteristic of updates to the machine learning model provided by a first subset of the plurality of computing nodes; ii) compare the aggregated characteristic to an equivalent reference; and iii) identify whether the first subset of nodes are contributing updates that are corrupting the machine learning model, based on the comparison.

According to a sixth aspect there is an apparatus for use in a distributed machine learning process for training a machine learning model, wherein the training is distributed across a plurality of computing nodes and updates to the machine learning model, as determined by the plurality of computing nodes, are aggregated using secure multi party computation. The apparatus is configured to: i) obtain an aggregated characteristic of updates to the machine learning model provided by a first subset of the plurality of computing nodes; ii) compare the aggregated characteristic to an equivalent reference; and iii) identify whether the first subset of nodes are contributing updates that are corrupting the machine learning model, based on the comparison.

Thus, in this disclosure, by comparing aggregated values of subsets of the plurality of computing nodes to reference values, it can be determined whether each subset contains node(s) that are corrupting the model. This leverages the fact that when multi-party computation is used, although contributions from individual computing nodes cannot be inspected directly, aggregated values for subsets of nodes in the distributed learning process are available for inspection. Thus, the method herein preserves privacy of individual computing nodes whilst providing the capability to identify if certain groups of participant(s) contain one or more computing nodes that are providing updates that are skewing the federation. As described below, the method may be used to isolate subsets of nodes, one or more of which are participating in a so-called “poison” attack. As such, embodiments herein provide accountability overlay for secure multi party techniques such as secure aggregation in a distributed machine learning process.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a node according to some embodiments herein;

FIG. 2 shows a computer implemented method performed by a node according to some embodiments herein;

FIG. 3 illustrates a distributed learning process according to some embodiments herein;

FIG. 4 illustrates a distributed learning process according to some embodiments herein; and

FIG. 5 shows a signal diagram according to some embodiments herein.

### DETAILED DESCRIPTION

Some embodiments herein relate to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

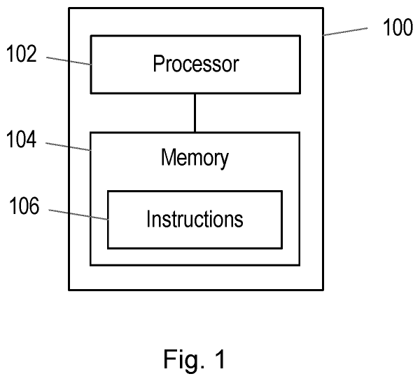

FIG. 1 illustrates a network or computing node 100 hereinafter referred to as a ‘node’ in a communications network according to some embodiments herein. Generally, the node 100 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to User Equipments (UEs) and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

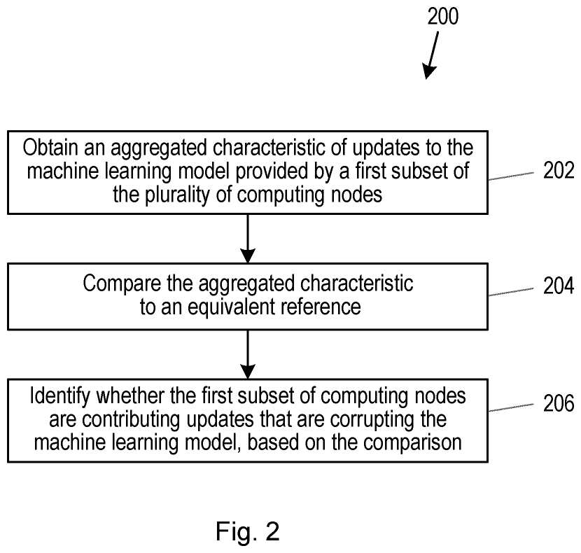

The node 100 is configured (e.g. adapted, operative, or programmed) to perform any of the embodiments of the method 200 as shown in FIG. 2 and described below. It will be appreciated that the node 100 may comprise one or more virtual machines running different software and/or processes. The node 100 may therefore comprise one or more servers, switches and/or storage devices and/or may comprise cloud computing infrastructure or infrastructure configured to perform in a distributed manner, that runs the software and/or processes.

The node 100 may comprise a processor (e.g. processing circuitry or logic) 102. The processor 102 may control the operation of the node 100 in the manner described herein. The processor 102 can comprise one or more processors, processing units, multi-core processors or modules that are configured or programmed to control the node 100 in the manner described herein. In particular implementations, the processor 102 can comprise a plurality of software and/or hardware modules that are each configured to perform, or are for performing, individual or multiple steps of the functionality of the node 100 as described herein.

The node 100 may comprise a memory 104. In some embodiments, the memory 104 of the node 100 can be configured to store program code or instructions 106 that can be executed by the processor 102 of the node 100 to perform the functionality described herein. Alternatively or in addition, the memory 104 of the node 100, can be configured to store any requests, resources, information, data, signals, or similar that are described herein. The processor 102 of the node 100 may be configured to control the memory 104 of the node 100 to store any requests, resources, information, data, signals, or similar that are described herein.

It will be appreciated that the node 100 may comprise other components in addition or alternatively to those indicated in FIG. 1. For example, in some embodiments, the node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of node 100 may be configured to control such a communications interface to transmit to and/or receive from other nodes or network functions requests, resources, information, data, signals, or similar.

Briefly, in one embodiment, the node 100 may be for use in a distributed machine learning process for training a machine learning model, wherein the training is distributed across a plurality of computing nodes and updates to the machine learning model, as determined by the plurality of computing nodes, are aggregated using secure multi party computation. The node 100 may be configured to: i) obtain an aggregated characteristic of updates to the machine learning model provided by a first subset of the plurality of computing nodes; ii) compare the aggregated characteristic to an equivalent reference; and iii) identify whether the first subset of nodes are contributing updates that are corrupting the machine learning model, based on the comparison.

As described above, secure multi party computational techniques are used for the purposes of preserving the privacy of users when collecting arithmetic data that will later on be used to produce aggregates—more specifically multi party sums of data.

Typically in these techniques, each user or contributor (e.g. computing node) provides individual contributions that are altered using an offset or shared secret. As such, the individual contributions are masked. However, the shared secret is such that when the contributions of the contributors are aggregated, it cancels out to leave the (true) value of the aggregated values. In this way, individual values may be masked, whilst still allowing accurate unmasked aggregated values to be obtained.

Examples of secure multi party computation techniques include but are not limited to secure aggregation.

Generally, as described in more detail below, the node 100 may be an aggregation point in the distributed learning process. E.g. such as a “central node” or “aggregation node” as described below. The node 100 may coordinate the distributed learning process in order to train the machine learning model. The node 100 may perform the method 200 described below.

Turning to FIG. 2 there is a computer implemented method 200 for use in a distributed machine learning process for training a machine learning model, wherein the training is distributed across a plurality of computing nodes and updates to the machine learning model, as determined by the plurality of computing nodes, are aggregated using secure multi party computation. Briefly, the method 200 comprises: i) obtaining 202 an aggregated characteristic of updates to the machine learning model provided by a first subset of the plurality of computing nodes, ii) comparing 204 the aggregated characteristic to an equivalent reference; and iii) identifying 206 whether the first subset of nodes are contributing updates that are corrupting the machine learning model, based on the comparison.

In some embodiments, the method may be performed by a first node in a communications network, such as the node 100 described above. As described above, the method 200 may be for use in identifying nodes in the plurality of computing nodes that are performing a data poison attack. More generally, the method 200 may be for use in determining nodes in a plurality of computing nodes that are providing inaccurate updates (whether maliciously or otherwise).

In some embodiments, the method 200 may be for use in training a machine learning model to predict actions that should be performed in a safety critical system. In such cases, the integrity of the machine learning model is critical, and the method may be used to quickly and accurately pinpoint and quarantine computing nodes that may be contributing malicious or otherwise inaccurate updates. Examples of safety critical systems include but are not limited to flight systems such as automated flight systems, remote surgery systems where a robot is used to perform a surgical procedure, train signalling systems, and systems for operating nuclear power stations.

In some embodiments, the machine learning model is for use in predicting actions that should be performed by an autonomous vehicle or autonomous aerial vehicle. Such machine learning models may take as input, for example, any one or combination of telemetry data, images, sensor data from e.g proximity sensors, and provide as output an action to be performed by the autonomous vehicle or autonomous aerial vehicle. Example outputs may be adjustments to the speed or trajectory of the autonomous vehicle or autonomous aerial vehicle. The skilled person will appreciate that these are merely examples however and that a machine learning model for use in predicting actions that should be performed by an autonomous vehicle or autonomous aerial vehicle may take as input other data to that described above. In such embodiments, the integrity of the machine learning model needs to be maintained in order for it to reliably predict appropriate, safe actions.

In some embodiments the machine learning model is for use in fault prediction. As an example, the machine learning model may be for use in predicting faults in a telecommunications network, or manufacturing system. As another example, the machine learning model may be for use in predicting faults in a safety critical system as described above. Such a machine learning model may take as input for example, log data and/or other performance data and provide as output an indication of a likelihood of a fault occurring. This is merely an example however and the skilled person will appreciate that a machine learning model for use in fault prediction may take a wide variety of input data and/or provide different outputs to those suggested herein. In this way the method 200 may be used to create more reliable fault predictions. Leading, e.g. to fewer faults in the safety critical system.

More generally, the machine learning model may be for performing actions in a communications system. Examples of such models include but are not limited to models for use in resource allocation/orchestration; models for use in optimising parameters in a communications network; and models for use in channel optimisation. In such examples, the method 200 may be used to make said models more efficient and reliable, thus improving the quality of experience of user operating in the communications network.

The method 200 may be performed responsive to detecting a reduction in performance of the machine learning model. In other words, the method 200 may be performed reactively, e.g. in response to a suspected poison attack, to determine and isolate the node(s) performing the attack.

The method may also be performed routinely, e.g. in the manner of a maintenance routine or as part of routine monitoring in order to proactively maintain the integrity of the model and the distributed learning process.

In more detail, the method 200 is for use in a distributed machine learning process. The skilled person will be familiar with distributed machine learning processes, but briefly, in a distributed learning process, a global copy of a machine learning model is held at central node (e.g. an aggregation point, or central server which may also be known as a “master” node). The central node sends copies to each of a plurality of computing nodes which may be e.g. edge devices or any other nodes in the system. Such computing nodes may be referred to as “workers”. The computing nodes create local copies of the machine learning model and perform training on their respective local copies based on local data. Outcomes of training, such as for example, updates to learnt hyper parameters, weights and/or biases of the model may be sent to the central node for use in updating the global copy of the model (e.g. through averaging). Examples of distributed machine learning processes include but are not limited to Federated Learning processes. In this way, training can be performed locally in a privacy aware manner, e.g. without having to move the data to a central repository.

Many types of machine learning models can be trained using distributed machine learning processes, including but not limited to classification or regression models such as deep neural networks, convolutional neural networks, and random forest models. The method may also be applied to distributed training of reinforcement learning models, where, e.g. updates to a Deep Q-Learning Network (DQN) in a Q-Learning process may be gathered centrally. The skilled person will appreciate that these are merely examples and that other types of machine learning models can also be trained in a distributed manner.

As used herein, the plurality of computing nodes can comprise any types of computational devices capable of joining a distributed learning process. Thus the plurality of computing nodes may comprise edge devices (e.g. such as UEs such as laptop computers, desktop computers, sensors) and/or any other computing devices, such as servers, virtual machines in the cloud, base stations (such as eNodeBs, gNodeBs etc). More generally the plurality of computing nodes may comprise any combination of devices capable, configured, arranged and/or operable to communicate wirelessly with network nodes and/or other wireless devices. Further examples of UEs include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. Examples of IoT devices include, for example, sensors and smart devices.

In embodiments herein, a machine learning model (otherwise referred to herein as “the model”), such as any of the types of model described above, is trained using a distributed machine learning process. The learning is performed by the plurality of computing nodes and updates to the machine learning model as determined by the plurality of computing nodes, are aggregated using a secure multi party computation process. The aggregation may be performed by the first node (or more generally what will be referred to herein as a “central” or “aggregating” node).

Secure multi party computation processes were described above, but in brief a secure multi party process uses masking or a shared secret to mask contributions from individual nodes. However when the masked contributions from individual nodes are aggregated (e.g. combined for example, using averaging) the masks cancel out to leave the true average value. In this way, masking of individual values may be performed, whilst still allowing true aggregates to be obtained. There are various different secure multi-party computation methods, such as for example, secure aggregation techniques.

In some methods, the secure multi party computation may use pairwise masking whereby the plurality of computational nodes are grouped into pairs. Each pair exchanges a mask (or “secret”) and this is subtracted from updates to one computational node in the pair and added to updates from the other computational node in the pair. Thus, the contributions from each individual computational node are masked, however if the updates are averaged, then the masks cancel out. More generally this method may be applied to groups of computational nodes of any size in so called “group-wise masking” where a shared secret (e.g. masking offset) is split between members of the group. Groups of participants may thus share a secret which is randomly split amongst them (but averages out when aggregated/averaged).

As described above, secure multi party computation preserves privacy of the members, but can have the downside of making it difficult to identify individual computing nodes that may be submitting inaccurate updates to the model (either accidentally or maliciously). It is an object of embodiments herein to be able to identify if one or more participants of a federation are trying to provide updates (e.g. such as neural parameters) which are harming the federation without breaking their privacy by honing in on particular groups that are most likely to be causing an issue.

In the methods herein, aggregated updates from a first subset of nodes are compared to a reference or control value (as explained in more detail below) to determine whether any of the first subset of nodes are contributing updates that are corrupting the machine learning model. This may be performed in an iterative manner on successive subsets of nodes until a group or pair are found that are contributing corrupting updates. This way, although individual contributions cannot be inspected directly, aggregated contributions from different subsets of nodes in the distributed learning process can be compared to look for outlying groups that may contain one or more computing nodes that may be corrupting a federation.

In more detail, in step 202 of the method 200, the method comprises i) obtaining an aggregated characteristic of updates to the machine learning model provided by a first subset of the plurality of computing nodes.

The first subset of nodes are selected (or targeted) for checking whether one or more of them are contributing updates that are corrupting the machine learning model.

The first set of nodes are selected such that when combined, an aggregated update from the first set of nodes is the true e.g. unmasked aggregation of the values. Put another way, the first subset of nodes are selected such that their respective masks, associated with the secure multi party computation, cancel each other out when aggregated.

The first subset of nodes may thus share a common secret according to the secure multi party computation method. In other words, the first subset of nodes may be a pair in a pairwise masking process, or a group in a groupwise masking process.

As used herein a groupwise masking process is a process whereby groups of participants share a secret which is randomly split amongst them. For example, an additive function could be used whereby each participant breaks their secret value with one or more random values (as many as the participants), where the sum of those values is the same as the original. Participant A holds this value and shares it with the others. The other participants do the same. The aggregation point receives all values which would also be cancelled out thus producing the wanted result which is the average in this case. In this manner groups of participants (e.g. of any size) may share a secret.

As such, in some embodiments, the step of selecting the first subset of nodes comprises selecting a group of nodes from the groupwise (or pairwise) secret sharing masking process as the first subset of nodes. In some embodiments, a plurality of groups or pairs in the groupwise or pairwise masking process may be selected as the first subset of nodes.

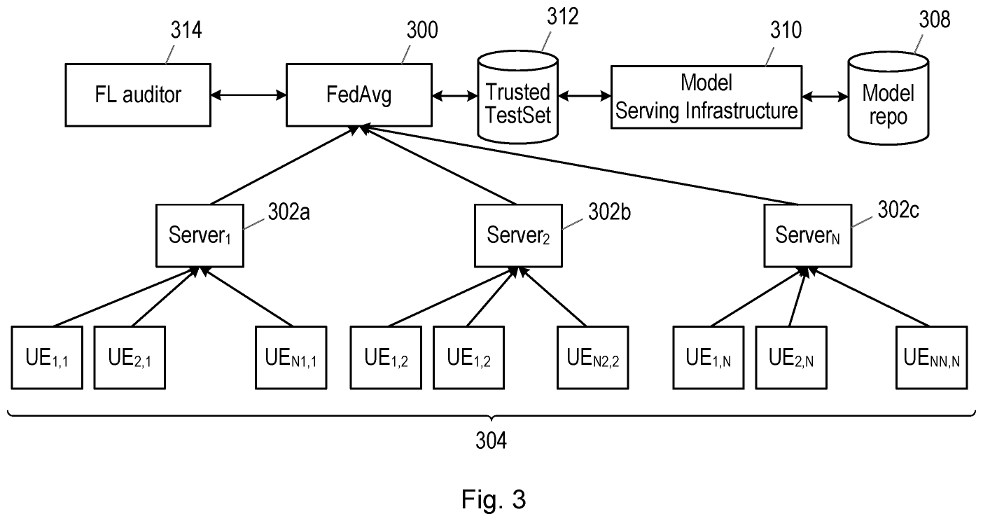

This is illustrated in FIG. 3 which shows an embodiment in a communications network where the method 200 is performed by a first node (e.g. central node or Federated Averaging “FedAvg” node) 300. The first node 300 coordinates the training of a machine learning model that is hosted in a model repo 308. The model serving infrastructure 310 hosts a trained (global) version of a machine learning model and makes it available to worker nodes in the distributed learning process. The first node 300 coordinates a distributed learning process for the machine learning model amongst three aggregation points 302a, 302b and 302c. Each of the aggregation points 302a, 302b and 302c aggregate updates to the machine learning model from a plurality of computing nodes represented in this example by the UEs UE_{1,1} to UE_{NN,N}. An aggregation point in this sense refers to the logical function that aggregates the updates. In this example, first node 300 sends a copy of the machine learning model to each of the aggregation points 302a, 302b and 302c which in turn send the model out to the plurality of computing nodes 304 UE_{1,1} to UE_{NN,N}. The plurality of computing nodes UE_{1,1} to UE_{NN,N} train the machine learning model on local data. The UEs 304 are grouped into groups according to a secure multi party computation method and each group shares a (different) secret/mask offset between themselves and uses the secret to obscure their update to the machine learning model. Aggregation points 302a, 302b and 302c aggregate (e.g. average or combine according to the type of multi party computation used) updates from the nodes in the plurality of computing nodes that send updates to them. The aggregated values are then sent to the first node 300 and combined (or aggregated) into a single update to the machine learning model.

In the example in FIG. 3, the first node 300 may perform the method 200. As an example, in step 202, the first subset of computing nodes may be selected by the first node 300. In other embodiments, the first node performing the method 200 may instruct a first aggregation point from the aggregation points 302a, 302b and 302c to partition the nodes submitting updates to the first aggregation point into a first subset of computing nodes and a second subset of computing nodes.

In some embodiments, in step 202 the first subset of computing nodes are selected from nodes associated with a common aggregation point in the distributed machine learning process. For example, the first subset of computing nodes may be associated with (e.g. provide updates to the model to) a single one of the aggregation points 302a, 302b or 302c. In other words, the first subset of computing nodes may be selected from the set of UEs, UE_{K}^{N} where K in {1 . . . K} UEs belong to aggregation point N and there are N in {1 . . . N}aggregation points with different UEs).

In other examples, the first subset of computing nodes are selected from nodes associated with different aggregation points in the distributed machine learning process.

In some embodiments, each UE may belong to only one aggregation point. In other words according to the notation above, UE1,1 !=UE1,2.

In some embodiments, the first node 300 may send a message to a second node 302, the second node being an aggregation point (302a, 302b or 302c) in the distributed machine learning process for the plurality of computing nodes, and the message may instruct the second node to determine the characteristic for the first subset of computing nodes. The method may further instruct the second node to determine the characteristic for other nodes in the plurality of computing nodes that are not in the first subset of computing nodes.

For example, the second node may be instructed to split the nodes sending updates to it, into two subsets or groups, and determine a separate aggregated characteristic for each group.

Once the first subset of nodes is determined or selected, then the aggregated characteristic for the first subset of nodes is determined. The aggregated characteristic may comprise a measure of convergence or accuracy of the machine learning model when the updates to the machine learning model from the first subset of nodes are aggregated into the machine learning model. For example, the characteristic may be a model accuracy metric such as, for example, the Mean Absolute Error (MAE), Mean Squared Error (MSE) or R-squared (R²). Such measures may indicate how quickly the machine learning model converges when updates from the first subset of computing nodes are incorporated into the model.

In some embodiments, the aggregated characteristic may comprise an aggregated parameter value obtained using an explainable Artificial Intelligence, XAI, process and the equivalent reference is a ground truth value for said parameter. For example, the parameter value obtained using the XAI process can be a measure of feature importance of an input feature to the machine learning model, e.g. when the updates to the machine learning model from the first subset of nodes are aggregated into the machine learning model.

The skilled person will be familiar with XAI processes, such as processes that shed light on the internal mechanisms by which a model makes decisions. XAI processes can be used to provide an indication of which input parameters are being given the most weight in decisions performed by the model, in other words the feature importance of each feature in coming to a decision or output. Herein, if updates from the first subset of nodes are shown to change the importance of a feature, then this may indicate that the first set of nodes is providing updates that might be corrupting the machine learning model.

After step 202, the method 200 comprises ii) comparing 204 the aggregated characteristic to an equivalent reference. In step 206 the method then comprises iii) identifying whether the first subset of nodes are contributing updates that are corrupting the machine learning model, based on the comparison. The equivalent reference (which may be thought of as a control value) is used to determine whether the updates provided by the first group of nodes are e.g. statistically different to the reference and if so, this may indicate that the first group of nodes contains one or more nodes that are providing erroneous or malicious updates.

In some embodiments, the equivalent reference comprises a measure of convergence or accuracy of the machine learning model when updates from the first subset of nodes are not aggregated into the machine learning model. Generally, if the machine learning model converges more quickly or is more accurate when the updates from the first subset of nodes are not aggregated into the machine learning model, compared with when they are, then this may indicate that the first subset of nodes are contributing updates that are corrupting the machine learning model.

For example, in step 206, the method may comprise determining that the first subset of nodes are contributing updates that are corrupting the machine learning model if the aggregated characteristic indicates that the machine learning model converges faster or is more accurate when updates from the first subset of nodes are not aggregated into the machine learning model compared to when updates from the first subset of nodes are aggregated into the machine learning model.

In some embodiments, the equivalent reference may comprise a measure of convergence or accuracy of the machine learning model as determined using (e.g. from training the model using) a trusted test dataset.

A trusted test dataset can be created by monitoring the interactions (inference requests) between a previously created machine learning model (product of a federation). A machine learning model is typically exposed over an API (i.e. HTTP). Therefore, API requests can be monitored and these requests can be used to form a test dataset. An example of such a request is shown below—>

### Request:

HTTP POST http://localhost:5000/api/v1.0/predictions
Content-Type: application/json
Body: {“data”: {“ndarray”: [[0.5, 0.9, 1, 3123.3, 223.2]]}} #input_vector

### Response:

Body: {“data”:{“names”:[ ],“ndarray”:[1]},“meta”:{ }} #output for this input_vector
Over time a trusted test set may be compiled in this way, as a combination of multiple such entries.

Note that the aforementioned request/response does not include encryption/authentication headers for simplicity. In a live production system, such requests are likely to be made by certified enterprise customers—therefore for each request we will also have a token that corresponds to the user (or service) that has initiated that request. Hence, they may be considered trusted data for use in training the machine learning model. As such, if when updates from the first subset of nodes are aggregated into the global copy of the machine learning model, the global machine learning model deviates significantly from a machine learning model trained using the trusted test dataset, then this may be an indication that the first subset of nodes are contributing updates that are corrupting the machine learning model.

In other words, AUC, MAE or MSE, R2, logloss, f1 (and other metrics) are impacted (are bellow expectation) when the FedAvg model is tested on the trusted test dataset.

In other embodiments, the equivalent reference may comprise a measure of convergence or accuracy of the machine learning model as determined from updates to the machine learning model provided by a second subset of the plurality of computing nodes. For example, updates obtained by different subsets of nodes may be compared to one another to look for outliers that may indicate updates that are corrupting the machine learning model.

This can be illustrated with respect to the example illustrated in FIG. 3. The first node 300 may send a message to a second node 302a (e.g. the second node being an aggregation point in the distributed machine learning process for the plurality of computing nodes), instructing the second node to determine the characteristic for a first subset of nodes UE_{1,1}, UE_{2,1.}, the first node 300 may further instruct the second node to determine the characteristic for a second subset of nodes, comprising the other nodes in the plurality of computing nodes UE_{3,1} . . . UE_{N,1} that are not in the first subset of nodes. The characteristic for the other nodes in the plurality of computing nodes may then be used as the equivalent reference.

In other words, the first node 300 may instruct the second node to split its workers into two subsets and aggregate values from each subset separately. The second node may thus provide two aggregated values back to the first node and these may be compared to determine whether one or other contains updates from nodes that may be corrupting the federation.

As noted above, in some embodiments, the aggregated characteristic comprises an aggregated parameter value obtained using an XAI process and the equivalent reference is a ground truth value for said parameter.

In some embodiments step 206 (determining that the first subset of nodes are contributing updates that are corrupting the machine learning model) may comprise determining that the first subset of nodes are contributing updates that are corrupting the machine learning model if the feature importance as determined by the first subset of nodes is different to the ground truth feature importance. A ground truth feature importance may be determined based on machine learning model updates from a trusted test dataset, or updates from other subsets of nodes as described above. In other words, if the XAI process indicates that the first subset of nodes are contributing updates that encourage the machine learning model to make decisions based more heavily on different input parameters to those updates from the trusted dataset, then this may indicate that the first subset of nodes are contributing updates that are corrupting the distributed learning process. In this way, it can be determined whether a first subset of nodes are providing updates to a machine learning model that are corrupting the machine learning model.

If the first subset of nodes are identified as contributing updates that are corrupting the machine learning model, then in the method 200 may further comprise quarantining the first subset of nodes from the distributed machine learning process. For example, the first set of nodes may be quarantined for a predefined interval of time or quarantined or filtered out completely.

Alternatively or additionally, the method may comprise investigating further, for example, by splitting the first subset of nodes into further subsets and repeating steps i)-iii) in an iterative manner until the smallest possible group of nodes is isolated that are causing the corrupting updates. E.g. until a pair of nodes are identified in a pairwise masking scheme, or a group of nodes are identified in a groupwise sharing making scheme.

Generally, the method 200 may be performed as an iterative process, for example, by repeating steps i)-iii) in an iterative manner for other subsets of nodes. As such, the method 200 may comprise determining that the first subset of nodes are not contributing updates that are corrupting the machine learning model, and repeating steps i)-iii) in an iterative manner for other subsets of nodes. As such, different subsets of nodes may be periodically checked in order to maintain the validity of the model.

In some embodiments, the method 200 may be applied iteratively and a process of elimination may be employed whereby the method proceeds by splitting the set of users in each aggregation in order to pinpoint potential suspects that may be harming a distributed learning process.

In this embodiment, each aggregation point splits the updates from the plurality of computing nodes that send updates to it (e.g. its workers) into a first and second subset of nodes and sends two sets of aggregated updates to the first node. In this embodiment, a characteristic of the second subset of nodes may be used as reference to the characteristic of the first subset of nodes.

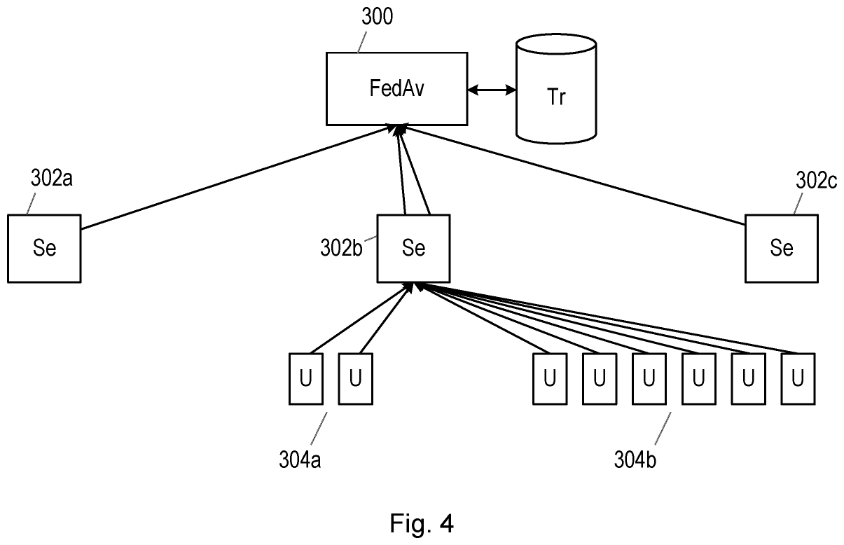

This is illustrated in FIG. 4 which illustrates an example according to some embodiments herein. In FIG. 4, the first node 300 receives two updates from a second node, aggregation point 302b because aggregation point 302b has split its plurality of computing nodes into a first subset of nodes 304a and a second subset of nodes 304b. In this example, the distributed learning process employs pairwise masking and thus a pair of nodes 304a is selected as the first subset of nodes. The remaining nodes that send updates to the second node 302b form a second subset of nodes and aggregated updates from the first subset of nodes and the second subset of nodes are sent to the first node 300.

To overcome the issue of “doubling” the updates that are received once we start splitting each aggregation into two groups (as above), a sampling technique may be used that produces groups of m aggregations of two while leaving the remaining (n-m) aggregations intact.

This may be performed in a combinatorial manner whereby a nCm formula is applied. In an example where n=3 groups, combinations of m=2 could be taken for which 3!/(2!−(3−2)1)=3. This would yield combinations such as 12, 13, 23 (12 means that group 1 and 2 are considered as one group and then the remaining group is 3, 13 means that group 1 and 3 are considered as one group and then the remaining group is 3, 23 means that 2 and 3 are considered as one group and the remaining group is 1).

This makes the proposed approach scale logarithmically at every investigation round.

In this embodiment, it may be assumed that each computing node of the plurality of computing nodes (UE) is associated with the same aggregating node (or server) within a federation (every round) and that will not change (it can change in the next federation). This assumption may break the original secure aggregation protocol and may break privacy. Here it is assumed that this constraint can be broken as a trade-off in order to gain accountability.

In this embodiment, it is assumed that the FedAvg process has access to a trusted test dataset (or hold out dataset) which is agreed and can be updated periodically only by trusted authorities. The trusted test dataset is obtained as described above and cannot be updated during the federation.

In this embodiment it is assumed that each of the plurality of computing nodes (e.g. each UE for example) within an aggregation contributes equally to the aggregation it belongs and in general to all other aggregations (has equally high enough samples). (If a UE does not meet this criterion and has for example a very high number of samples as opposed to others than it is more likely that this UE is harming the federation).

In this embodiment, the federation is “harmed” (or an input is causing an issue) when AUC, MAE or MSE, R2, logloss, f1 (and other metrics) are impacted (are bellow expectation) when the FedAvg model is tested on the trusted test dataset. Moreover, Shapley Additive exPlanations (SHAP) explainability analysis is performed using the Trusted Test Set to ensure that feature importance is sustained as well.

In the process of detecting which user (or more accurately which pair of users maybe harming a federation, two cases may be identified.
1) Two or more users in the same aggregation are causing an issue
2) Two or more users in different aggregation are causing an issue

As noted above, the resulting suspect groups can be treated differently by the secure aggregation process, for example, they can be quarantined for a set amount of time, or completely filtered out.

Example code for determining the first and second subsets of nodes is given below.

```
def pinpoint_suspects(suspected_servers, remaining_servers):
  aggregations = { }
  for s in suspected_servers:
    u, v = s.split( )
    aggreations[s.id + “_1”].append(s.aggregate(u))
    aggregations[s.id + “_2”].append(s.aggregate(v))
  for s in remaining_servers:
    aggregations[s.id].append(s.aggregate( ))
  suspected_servers = [ ]
  for k, v in aggregations: # leave one out
    suspected_input = aggreations[:i] + aggregations[i+1:]
    m = fedAvg(aggregations)
    v = validate(m, trusted_test_set)
    if ( v.auc <= expected_auc ):
      suspected_servers.append(k)
  return suspected_servers
def build_test_groups(list_of_servers, max_items): # n!/(n−k)!k!
  random_list = shuffle(list_of_servers)
  samples = itertools.combinations(random_list, max_items)
  output = [ ]
  for sample in samples:
    output.append(sample, complement(list_of_servers, sample)
  return output
def accountable_federation(list_of_servers):
  pin_pointed_suspects = [ ] # original round of federated learning
  aggregations = { }
  for s in list_of_servers:
    aggregations[s.id].append(s.aggregate( ))
  m = fedAvg(aggregations)
  v = validate(m, trusted_test_set)
  if v.auc <= expected_auc:
    test_groups = build_test_groups(list_of_servers, max_items)
    while ( len(pin_pointed_suspects) == 0 || len(test_groups) > 0 ):
      test_group = test_groups.pop( )
      suspected_servers = test_group.suspect_servers
      remaining_servers = test_group.remaining_servers
      suspects = pinpoint_suspects(suspected_servers, remaining_servers)
      pin_pointed_suspects.append(suspects)
  return pin_pointed_suspects
```

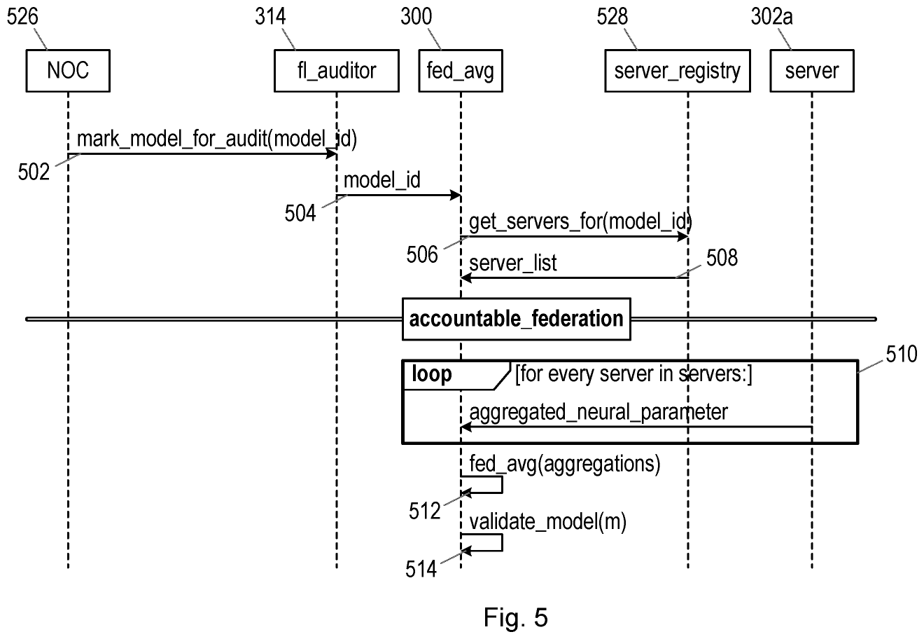

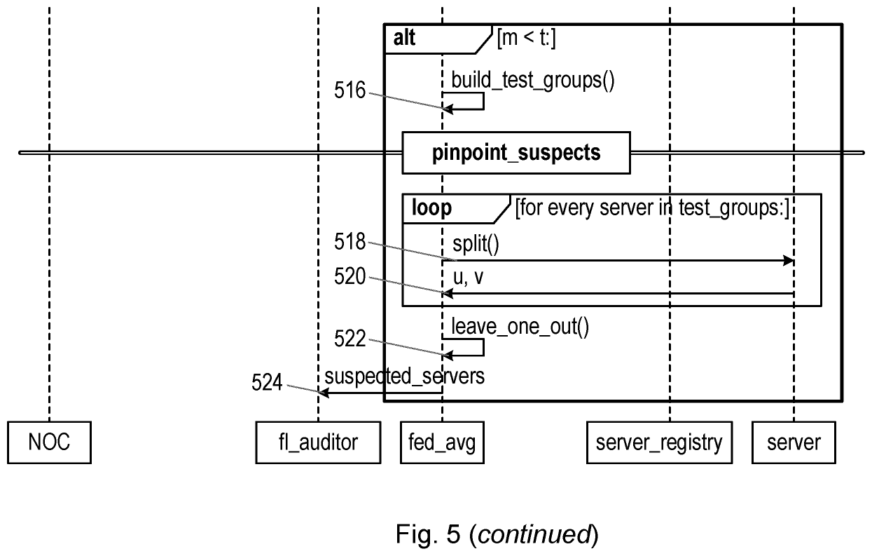

Turning now to FIG. 5 there is a signal diagram suitable for use in a distributed learning environment. The signal diagram in FIG. 5 illustrates example signals that may be send between the different nodes illustrated in the example shown in FIG. 3.

In this example there is a Network Operation Centre (NOC) 526, a fl_auditor 314, a first node 300, a server registry 528, a server (or second node) 302a forming an aggregation point in the distributed learning process and a fl_auditor 314.

In step 502 the NOC 526 sends a message to the fl_auditor 314 indicating that a particular machine learning model needs to be audited. The fl_auditor sends the model id to the first node in step 504.

In step 506 the first node sends a message to the server registry 528 requesting a list of server IDs of servers (e.g. second and/or subsequent nodes) that are acting as aggregation points in the distributed learning scheme for the machine learning model that needs to be audited. In step 508 the server registry 528 sends the list of servers to the first node 300.

The first node then performs the method 200 as described above. In step 510, for every server that is aggregating updates for the machine learning model, aggregated neural parameters are sent to the first node 300 (step 512) and the first node validates the machine learning model (step 514).

In step 516 the first node 300 performs the build_test group algorithm described above and in steps 518 and 520, selects a first subset of nodes sending updates to one of the aggregation points (e.g. a second node as described above) using the split( ) algorithm described above. At 522, the first node then performs steps 204 and 206 on the updates received from the first subset of nodes to determine whether the first subset of nodes is contributing updates that are corrupting the machine learning model. Any suspected servers reporting updates that may be corrupting the machine learning model are reported to the fl_auditor in step 524.

In this way, nodes providing erroneous or malicious updates may be flagged for quarantine and the integrity of the machine learning model may thus be preserved.

In another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer implemented method for use in a distributed machine learning process for training a machine learning model, wherein the training is distributed across a plurality of computing nodes and updates to the machine learning model, as determined by the plurality of computing nodes, are aggregated using secure multi party computation, the method comprising:
i) obtaining an aggregated characteristic of updates to the machine learning model provided by a first subset of the plurality of computing nodes;
ii) comparing the aggregated characteristic to an equivalent reference; and
iii) identifying whether the first subset of computing nodes are contributing updates that are corrupting the machine learning model, based on the comparison.

2. A method as in claim 1 further comprising selecting the first subset of nodes, and wherein the first subset of nodes are selected such that their respective masks, associated with the secure multi party computation, cancel each other out when aggregated.

3. A method as in claim 2 wherein the secure multi party computation uses a groupwise secret sharing masking process and the step of selecting the first subset of nodes comprises:
selecting a group of nodes from the groupwise secret sharing masking process as the first subset of nodes.

4. A method as in claim 1 wherein the aggregated characteristic comprises a measure of convergence or accuracy of the machine learning model when the updates to the machine learning model from the first subset of nodes are aggregated into the machine learning model.

5. A method as in claim 4 wherein the equivalent reference comprises:
a measure of convergence or accuracy of the machine learning model when updates from the first subset of nodes are not aggregated into the machine learning model;
a measure of convergence or accuracy of the machine learning model as determined using a trusted dataset; or
a measure of convergence or accuracy of the machine learning model as determined from updates to the machine learning model provided by a second subset of the plurality of computing nodes.

6. A method as in claim 1 wherein the step of identifying whether the first subset of nodes are contributing updates that are corrupting the machine learning model comprises:
determining that the first subset of nodes are contributing updates that are corrupting the machine learning model if the aggregated characteristic indicates that the machine learning model converges faster or is more accurate when updates from the first subset of nodes are not aggregated into the machine learning model compared to when updates from the first subset of nodes are aggregated into the machine learning model.

7. A method as in claim 1 wherein the aggregated characteristic comprises an aggregated parameter value obtained using an explainable AI, XAI, process and the equivalent reference is a ground truth value for said parameter.

8. A method as in claim 7 wherein the parameter value obtained using the XAI process is a measure of feature importance of an input feature to the machine learning model.

9. A method as in claim 8 wherein the step of identifying whether the first subset of nodes are contributing updates that are corrupting the machine learning model comprises:
determining that the first subset of nodes are contributing updates that are corrupting the machine learning model if the feature importance as determined by the first subset of nodes is different to the ground truth feature importance.

10. A method as in claim 1 further comprising:
determining that the first subset of nodes are not contributing updates that are corrupting the machine learning model; and
repeating steps i)-iii) in an iterative manner for other subsets of nodes.

11. A method as in claim 1 wherein the method is performed responsive to detecting a reduction in performance of the machine learning model.

12. A method as in claim 1 wherein the first subset of nodes are selected from nodes associated with a common aggregation point in the distributed machine learning process.

13. A method as in claim 1 wherein the first subset of nodes are selected from nodes associated with different aggregation points in the distributed machine learning process.

14. A method as in claim 1 further comprising:
quarantining the first subset of nodes from the distributed machine learning process, if the first subset of nodes are identified as contributing updates that are corrupting the machine learning model.

15. A method as in claim 1 wherein the method is performed by a first node in a communications network.

16. A method as in claim 15 wherein the first node is configured to
send a message to a second node, the second node being an aggregation point in the distributed machine learning process for the plurality of computing nodes, and wherein the message instructs the second node to determine the characteristic for the first subset of nodes.

17. A method as in claim 16 wherein the message further instructs the second node to determine the characteristic for other nodes in the plurality of computing nodes that are not in the first subset of nodes; and
wherein the characteristic for the other nodes in the plurality of computing nodes is used as the equivalent reference.

18. A method as in claim 1 wherein the method is for use in identifying nodes in the plurality of computing nodes that are performing a data poison attack.

19. A method as in claim 1 wherein the method is used in training the machine learning model for use in a determining actions that should be performed in a safety critical system.

20.-24. (canceled)

25. An apparatus for use in a distributed machine learning process for training a machine learning model, wherein the training is distributed across a plurality of computing nodes and updates to the machine learning model, as determined by the plurality of computing nodes, are aggregated using secure multi party computation, the apparatus comprising:
a memory comprising instruction data representing a set of instructions; and
a processor configured to communicate with the memory and to execute the set of instructions, wherein the set of instructions, when executed by the processor, cause the processor to:
i) obtain an aggregated characteristic of updates to the machine learning model provided by a first subset of the plurality of computing nodes;
ii) compare the aggregated characteristic to an equivalent reference; and
iii) identify whether the first subset of nodes are contributing updates that are corrupting the machine learning model, based on the comparison.

26.-29. (canceled)
